(19) United States
(12) Patent Application Publication
(10) Pub. No.: US 2006/0033610 A1
(43) Pub. Date: Feb. 16, 2006

(54) Method and apparatus for communication with remote electronic devices

(76) Inventor: Edwin Alberto Martinez, Santo Domingo (DO)

Correspondence Address: PATENT DEPARTMENT;SKADDEN, ARPS, SLATE, MEAGHER & FLOM LLP, FOUR TIMES SQUARE, NEW YORK, NY, 10036, US

(21) Appl. No.: 10/916,174

(22) Filed: Aug. 11, 2004

(51) Int. Cl. B60Q 1/00

(52) U.S. Cl. 340/425.5

(57) ABSTRACT

A method for communicating commands and data to remote electronic devices over a wireless link is facilitated by interposing a processing module between a user control device and the remote electronic devices. The processing module is configured to interact with a wireless services provider in processing commands and data which is exchanged between the user control device and the remote electronic devices. The processing module leverages the interaction with the wireless service provider to enhance communication quality as well as provide added functionality to associated users.

### FIELD OF THE INVENTION

The present invention relates to communications systems and, in particular to interacting with Remote Electronic Devices by way of a central server.

### BACKGROUND

Modern times have brought along a human dependency on electronic devices. These devices range from those protecting homes to those controlling a vehicle's engine or those that track electrical utility usage. Inherent in employing and relying on such devices is the need to properly configure and communicate with a device. Often times, the device is within arms reach or visual distance from the user whereby the user employs a control panel or instrument to communicate with the device. This is the case with devices such as television sets, microwaves, and cellular telephones. However, some devices are often outside the visual or physical reach of the user but nonetheless are relied upon for their intended function. For example, a vehicle alarm system should be trusted to properly operate and prevent vehicle theft, even when the user is not in the vicinity of the vehicle. In other instances, there are significant costs associated with a user traveling to the vicinity of the device to initiate communication. For example, an electronic device may be employed to track home electricity usage. However, a user still needs to travel to the location where the device is installed to read level indications or otherwise configure the device which may involve significant costs.

Some of the existing methods for communication with electronic devices employ telephone communication over a modem to communicate with the devices. These include a remote computer or network switch, each communicating data to the device. However, at times, a telephone communication line is not available for establishing modem communication. Other times, implementing modem functionality may increase the cost of a device in a prohibitive manner, especially with home consumer devices. Accordingly, there is a need for an economical and flexible method for facilitating communication with a remote electronic device.

### SUMMARY

To overcome the limitations discussed above, the present invention provides a method and system for communicating with an electronic device over a wireless cellular telephone network by interposing an application server at the wireless carrier facility. Specifically, the invention provides a control system for controlling and adjusting autonomous remote eectronic devices via a localized central server. The invention ensures a reliable and robust communication session by employing intelligent command processing at the wireless provider facility to ensure that the electronic device reliably receives and transmits data.

### BRIEF DESCRIPTION OF THE DRAWINGS

FIG. 1 illustrates the geographical location and interaction between logical elements in an example system;

FIG. 2 illustrates the logical components associated with an application server associated with a wireless carrier processing commands in a system of the invention;

FIG. 3 illustrates data flow between logical components in the application server of FIG. 2 when processing user commends;

FIG. 4 illustrates data flow between logical components in the application server of FIG. 2 when processing device messages; and

FIG. 5 is a flow diagram illustrating the operation of a message translation module of the application server.

### DETAILED DESCRIPTION

The present invention facilitates robust communication between user control devices and remote electronic devices over a wireless connection by providing an application server at a wireless carrier facility. The user control device preferably includes Short Message System (SMS) transmission capability, which is used to transmit and receive a byte sequence or alphanumeric characters over other wireless communication protocols. The alphanumeric character SMS format provides a command set which is specific to a predetermined device. For example, a vehicle alarm system may be associated with a command set which controls a specified group of functions such as arming and disarming, managing alarm condition triggers, and setting the remote electronic device's operation mode (e.g., block, silence, normal, discrete, and valet). The command set also includes a configuration function which manages adjustments of the remote electronic device's operational parameters.

The application server of the invention is adapted to receive a command from a user control device. The application server processes, verifies, authorizes and deploys the command as well as optionally provides a message indicating the execution status to the user control device. In one embodiment, the application server accesses status information received from the remote electronic device, which is normally not available to a user control device, by virtue of its close association with the wireless communication link provider. This close association with the wireless carrier allows the application server to process commands in a reliable and efficient manner. As may be appreciated from the discussion below, employing an application server at the wireless carrier also allows for processing command types which were not available in system employing prior communication methods. For example, by using information from the wireless carrier a user is able to track the approximate position of his vehicle fitted with a remote electronic device.

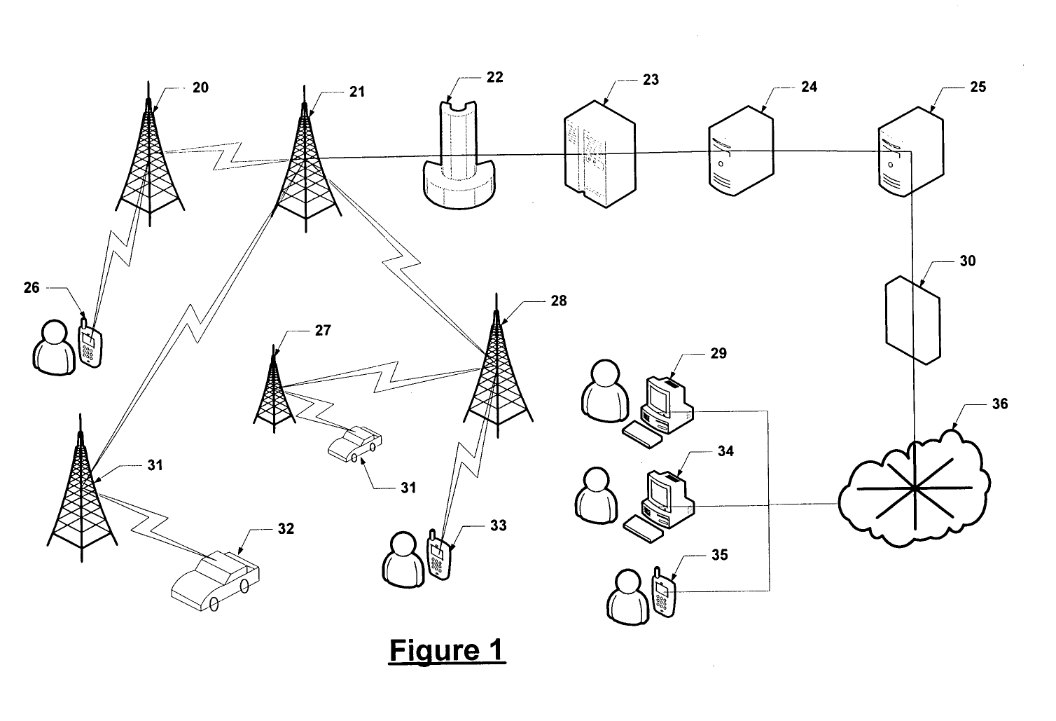

The structure and operation of the application server is presented below in FIG. 1 by reference to an embodiment of the invention which provides an examplary vehicle security system configuration. Vehicles 31, 32 are fitted with vehicle security devices (not shown) including operative components available from known car alarms. The particular vehicle security devices applicable to the configuration of FIG. 1 preferably include a module for processing and communicating SMS format messages over a wireless communication link. A user control device, such as a cellular telephone 33, 35 or a computer system 29, 34 is available to users for communicating desired commands. The commands are preferably transmitted to the application server over a communication link associated with the user control device. A computer system 29, 34, 35 is preferably coupled to the Internet 36 to transmit commands to the security system over an internet connection. A firewall 30 associated with the internet connection is illustrated as controlling network traffic between the wireless carrier location 22, 23, 24, 25 and the internet 36. As may be appreciated, the use of the firewall 30 is optional and is only intended to illustrate an example network flow between a computer system 29, 34, 35 and the application server 25. In the illustrated embodiment, a server running a map and tracking module 24 is preferably provided on an independent system due to the processing capacity required for the associated functionality.

The application server 25 is coupled to the internet 36 by the firewall 30 to receive user communication. The application server 25 is also coupled to an SMSC server 23 which relays SMSC messages received by way of a wireless network. The SMSC server 23 is coupled to a central wireless switch 22 which receives SMS messages transmitted over the wireless network. A plurality of cell towers 20, 21, 27, 28, 31 interacts with wireless user devices 26, 33 and remote modules in vehicles 31, 32 to transmit or receive SMS messages. The cell towers 20, 21, 27, 28, 31 preferably include transmitters and receivers for cellular communication as is known in the art.

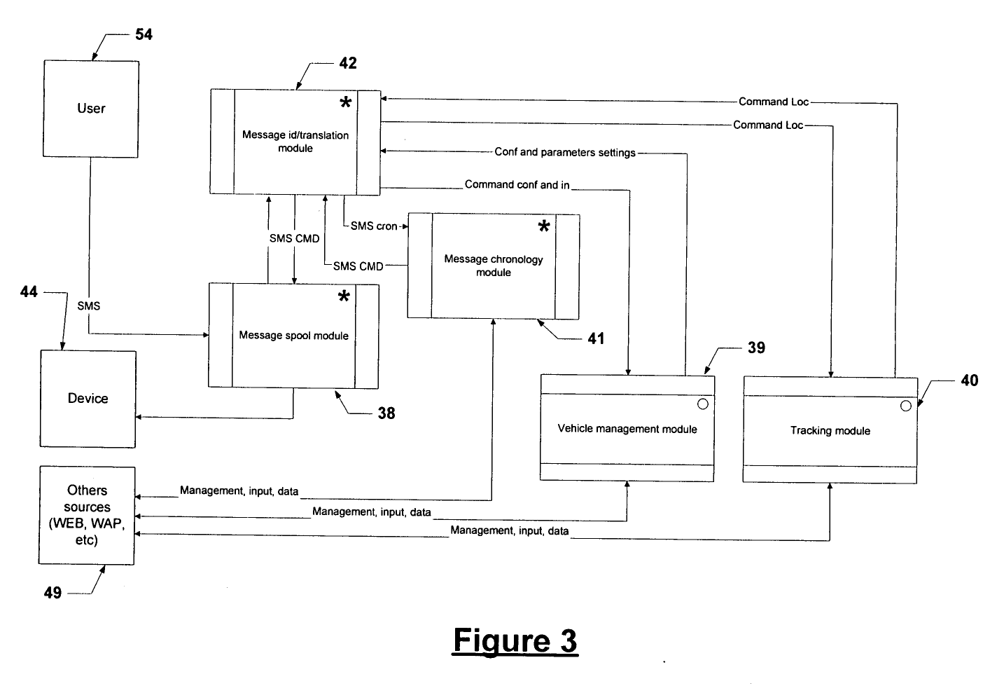

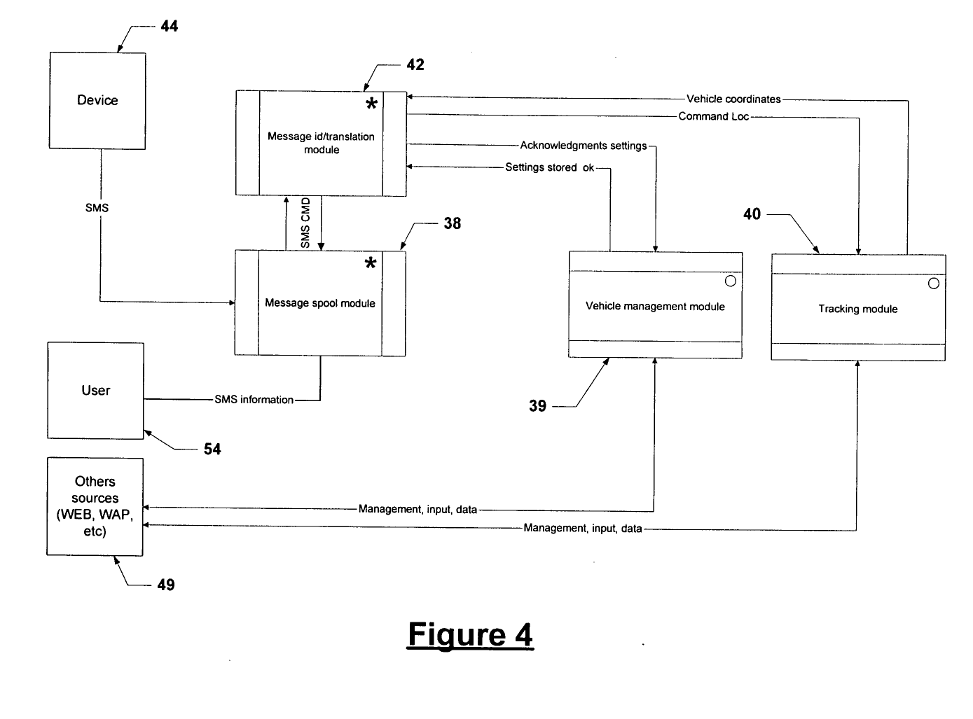

In operation, a user command is facilitated by the transmission of SMS messages to the remote module in a vehicle 31, 32 after some processing by the application server 25 at the wireless carrier. A first processing flow is provided for processing commands received from user devices (FIG. 3). A second, reverse, processing flow is provided for processing data received from the security devices (FIG. 4).

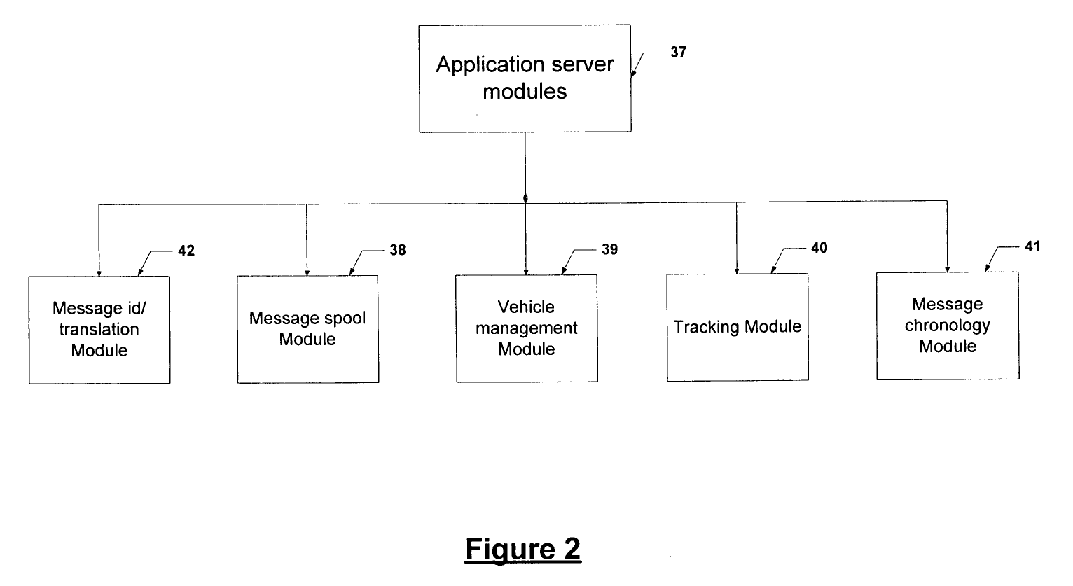

FIG. 2 illustrates logical components associated with an application server 25 and tracking module 24 of the invention. The components may be facilitated by software programs running on one or several computer systems. The components are discussed below as independent software modules. However, as may be appreciated, two or more of the modules can be combined depending on the particular implementation platform employed. The discussion below further presumes that the wireless carrier has available a server system which is adapted to transmit and receive SMS message data to and from the application server components.

A main server module component 37 serves to integrate the various components so as to facilitate transmission of data between components. The main server module 37 also facilitates invocation of tasks to be executed by one or more component, as applicable to the desired procedure.

A translation module 42 is provided to facilitate proper formatting of instructions to a vehicle security device in accordance with received user commands. The translation module 42 generally receives commands from a user or status messages from the vehicle security device. The translation module 42 then generates one or more messages to be delivered to the destination user control device or user terminal so as to execute the desired command or convey the applicable status data. In one embodiment, the translation module 42 identifies the message type prior to initiating processing. Once the message type is identified, the translation module 42 retrieves data relating to the particular electronic device associated with the device identifier to which the command was directed. Knowing the message type and the characteristics associated with the vehicle security device, the message translation module 42 applies the proper translation algorithm to the received message so as to facilitate proper processing. Employing a proper translation algorithm allows the translation module 42 to format and execute commands in accordance with the particular device attributes. These attributes include available command sets, device location, device sensitivity, device protection level.

A message spool module 38 provides messages for transmission by the wireless carrier. The message spool module 38 preferably stores messages for transmission to security devices or user terminals which are generated by the message translation module. In some embodiments, the message spool module 38 facilitates delivery of each message by employing data available only to the wireless carrier such as network load, device availability, signal quality, and device serving cells. The message spool module 38 also tracks each message by reference to delivery status data available to the wireless carrier.

A management module 39 facilitates configuration of the vehicle security device by reference to a configuration database. The management module 39 allows the application server 25 to initialize each vehicle security device with a corresponding set of parameters as provided by the user or system administrator. Example initialization parameters include: timers, activation type, location, event reports, and schedule for remote ignition duration.

A tracking module 40 facilitates geographical location identification functions. Such tracking is provided by employing known algorithms which would be apparent to one of ordinary skill in the art. Commands and features that require a tracking feature include, a location request (user requesting vehicle position), frontier control (alarm is programmed to notify when a vehicle exits defined boundary), speed alert (alarm is programmed to notify when a vehicle exceeds a specific speed), trajectory analysis (user may visualize the full trajectory of his vehicle in a set period of time). The above commands further allow parameter definitions such as time interval filters (alarms are valid only during a specified schedule) and duration filters (states must remain active for a set period of time).

A message chronology module 41 facilitates scheduling of message transmission to the vehicle security device. The application server 25 employs the message chronology module 41 to transmit commands to the message spool module 38 for recurring tasks, or schedules tasks, such as daily vehicle startup.

FIG. 3 illustrates data paths between the logical modules of FIG. 2 when the application server 25 is processing a command from a user control device. A user may employ a user control device, such as a mobile phone or a computer terminal, to transmit a command to the vehicle security device. The command is preferably in the form of an SMS message. In the example embodiment, where the remote electronic device is a vehicle security device, the available commands include Activate, Deactivate, Panic, Location Petition, Block, Unblock, Valet, Unvalet, Discrete, and Undiscrete. When the user employs a mobile phone to transmit the SMS command, the recipient vehicle security device is identified by reference to the target telephone number. Specifically, the target telephone number is used by the application server translation module 42 and message spool module 38 to identify the mobile communication component associated with the electronic device. It may be appreciated that, because command processing takes place at the wireless carrier, there is no correlation between the target telephone number and the actual remote electronic device or devices. This is a valuable security feature provided by a communication system in accordance with the invention. For example, a command directed to a first number can be processed to direct a first device to perform a task while a command directed to a second number can be processed to direct a plurality of devices, including the first device, to perform a plurality of tasks. As may be appreciated, the processing of commands at the wireless carrier by the application server thereby allows for significant flexibility and convenience over present methods which only employ the wireless carrier as a transmission conduit.

Referring now to FIG. 3, an SMS message is received by the message spool module 38 to identify the device or set of devices to which the message is directed by reference to the target number. The SMS message is provided to the translation module 42 for processing. The translation module 42 employs a translation database (not shown) to determine the appropriate processing for the command. If the command requires location tracking, the translation module 42 forwards the location tracking command to the tracking module 40. The tracking module facilitates device tracking by employing external modules 49, such as for example GSM Cell Network Information processing module, CDMA Cell Network Information processing module, and a GPS Network Information processing module. If commands are to be provided to the vehicle security device as part of the tracking process, the tracking module 40 provides such commands to the message spool system by way of the translation module 42. If the command is for modifyng configuration parameters of the vehicle security device, the translation module forwards the configuration command to the management module 39. The management module 39 processes configuration commands in accordance with stored data and data acquired from external sources 49 such as the user control device, the wireless carrier network itself, and the vehicle security device. If the command is a request to schedule a future command, the translation module 42 forwards the command to the message chronology module 41. In one embodiment, the message chronology module 41 stores the command in a transmission queue to provide a future SMS message to the device.

When the message chronology module 41 determines that a command should be transmitted to an vehicle security device, in accordance with stored database data providing command schedules, the module provides at least one SMS message, corresponding to a command, to the translation module 42.

Once the translation module 42 has completed the processing of an SMS command, at least one resultant SMS command is provided to the message spool module 38 for transmission to the security device. As may be appreciated, it is not necessary for the translation module 42 to modify the SMS message at all times and there may be instances when an identical SMS message is received by and transmitted from the translation module.

The message spool module 38 stores SMS messages that are to be directed to user devices associated with the application server 25. The message spool module 38 employs the services of the wireless carrier to transmit the SMS messages. As may be appreciated, different wireless carriers may employ different method to facilitate transmission of SMS messages to remote electronic devices. However, the present invention is equally applicable to other method for transmitting SMS messages to remote electronic devices as long as messages are appropriately delivered to the devices and a corresponding status is communicated to the message spool module.

FIG. 4 illustrates data paths between the logical modules of FIG. 2 when the application server 25 is processing a command received from the vehicle security device. The vehicle security device 44 transmits an SMS message to the application server 25 by employing the wireless transmission module of the vehicle security device. As may be appreciated, the vehicle security device 44 generally includes a processor for controlling various system operations as well as a wireless transmission module to facilitate communication of SMS messages to the application server 25 at the wireless carrier. Details relating to the specific structure of the vehicle security device 44 are not essential for the description of the present invention and would be apparent to one of ordinary skill in the art.

The message spool module 38 processes the received SMS message to provide a proper response to either the user control device 54 or one of the application server modules. To facilitate proper processing, each such response data is preferably formatted in a predetermined form, which includes data identifying the response as directed to one of the several application server modules. When the vehicle security device message is in response to a location function request, the response location data is provided to the tracking module 40. In some states of the application server 25, the tracking module 40 responds to the location data with a reply command or acknowledgement. In some embodiments, the tracking module 40 employs external data sources 49 in processing the location data. Such external sources include the sources discussed above with respect to the tracking module 40 location command processing. When the security device message is in response to a configuration command, the message data is provided to the management module 39. The message is then processed by the management module 39, with or without reference to the external sources 49 discussed above. In some states of the application server 25, a response indication is transmitted to the translation module 42 for delivery to the user control device 54.

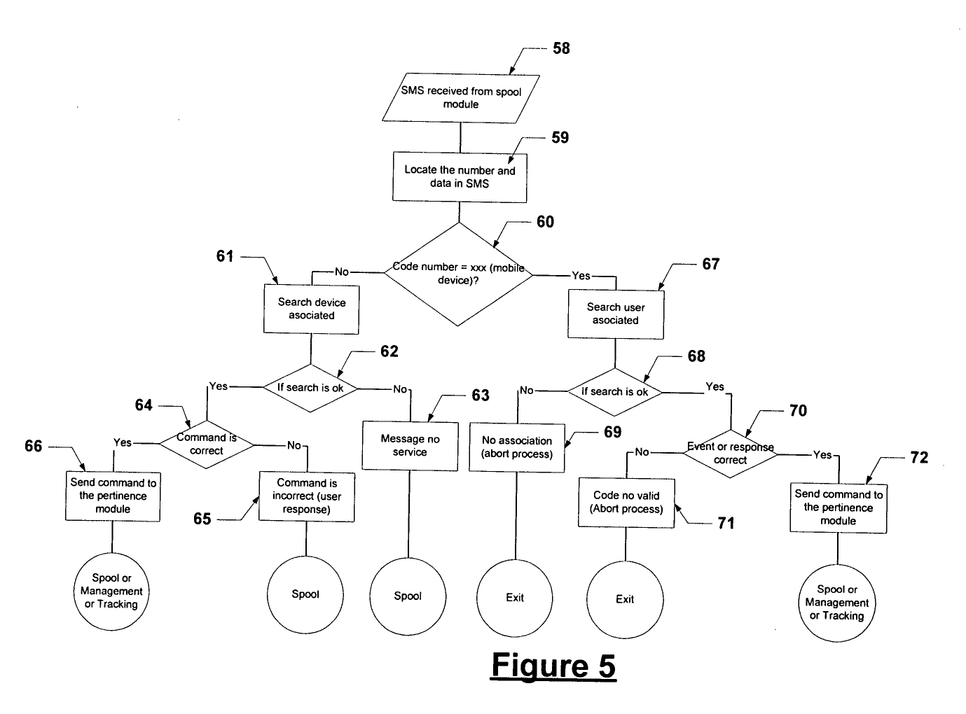

FIG. 5 is a flow diagram illustrating the operation of the translation module 42. An SMS message is received from the spool module originating either from a user device or from the security device (Step 58). The translation module extracts both the address identifier from the SMS as well as the associated message data (Step 59). As discussed above, the address identifier is a subscriber number that is associated with either a security device or a user service. The translation module then determines whether the address identifier is a user or a security device (Step 60). If the address is for a user, the translation module attempts to retrieve the record associated with the user device (Step 67). If a record is retrieved (Step 68), the translation module determines whether the event or response encoded in the SMS message is correct (Step 70), by reference to registered model and version identifier for the vehicle security device, and the predefined format in which it is registered to send data, as well as well known mechanisms, such as cyclic redundancy check, and transaction specific identifiers. If the command is correct the translation module sends the command to the appropriate module for processing (Step 72). If the command is not correct, the translation module aborts the process and returns a notification to the sender and the fault data is recorded (Step 71). If the translation module is not able to retrieve the user record, the process is aborted since no user is properly associated with the message and the fault data is recorded (Step 69).

The translation module processes a command directed to a vehicle security device by searching for data record associated with the device (Step 61). If a record is not located, the translation module generates a no service message and provides the message to the spool module for transmission to the source of the command (Step 63). If a record is retrieved for the vehicle security device, the translation module determines whether the command is correct by reference to the procedure described above (Step 64). If the command is correct, the translation module transmits the command data to the appropriate module associated with the command as discussed above with reference to FIG. 3 (Step 66). If the command is incorrect, the translation module generates an error message and provides the message to the spool module for transmission to the source of the command (Step 65).

Although the present invention was discussed in terms of certain preferred embodiments, the invention is not limited to such embodiments. A person of ordinary skill in the art will appreciate that numerous variations and combinations of the features set forth above can be utilized without departing from the present invention as set forth in the claims. Thus, the scope of the invention should not be limited by the preceding description but should be ascertained by reference to claims that follow.

1. A method for a user device control of a remote module, comprising:
the user device transmitting a command to a communication module over a wireless link;
the communication module processing the command to provide at least one SMS message;
the communication module transmitting the SMS message to the remote module; and
the remote module processing the SMS to control an operation of the remote module.

2. The method of claim 1, wherein the user device transmitting a command to the communication module is by the communication module intercepting an SMS message transmitted from the user device to a wireless identifier associated with the remote module.

3. The method of claim 1, wherein the command is transmitted as e-mail message text.

4. The method of claim 1, wherein the command is transmitted by a user device computer coupled to the internet.

5. The method of claim 1, wherein the command is transmitted by a user device mobile telephone to a mobile network.

6. The method of claim 1, wherein the processing module is provided at a wireless carrier location.

7. The method of claim 1, wherein the processing module is on the same LAN as an SMS module of a wireless carrier which is used to transmit the SMS message to the remote module.

8. The method of claim 1, wherein the processing module provides a plurality of SMS messages by reference to a single command.

9. The method of claim 1, wherein the transmission of SMS is over wireless network.

10. The method of claim 1, wherein the remote module controls an automobile vehicle alarm system.

11. The method of claim 1, wherein the remote module reads an electrical meter.

12. The method of claim 1, further including receiving a command from an automatic module transmitting commands according to schedule.

13. The method of claim 1, further including queuing a preference database for remote module configuration data.

14. The method of claim 1, further including employing SMS message to configure operation of remote module.

15. The method of claim 1, further including receiving remote device status data as part of SMS message text received from the remote device.

16. A method for retrieving remote device data, comprising:
receiving at least one SMS message from a remote device;
processing the message by a processing module to provide a status indication; and
transmitting the status indication to a user display device to display device data to a user.
